(19) United States
(12) Patent Application Publication
(10) Pub. No.: US 2002/0117233 A1
(43) Pub. Date: Aug. 29, 2002

(54) Disposable/reusable lubrication container system

(76) Inventor: Matthew Kenyon Kellogg, Seattle, WA (US)

Correspondence Address: BLACK LOWE & GRAHAM, 816 SECOND AVE., SEATTLE, WA, 98104, US

(21) Appl. No.: 09/909,615

(22) Filed: Jul. 20, 2001

Related U.S. Application Data
(60) Provisional application No. 60/272,372, filed on Feb. 27, 2001.
(60) Provisional application No. 60/275,587, filed on Mar. 12, 2001.

(51) Int. Cl. B67C 3/02

(52) U.S. Cl. 141/98; 141/59; 141/383; 141/285

(57) ABSTRACT

A disposable lubricating container system including a disposable container, a carrier, a sealing unit and transfer tubes. The carrier rigidly attaches itself to an engine or other machine part and the container attaches to the carrier. The container mates with the carrier to securely hold the container while being easily removed or inserted into the carrier. The sealing unit attaches to a neck portion of the container and serves to provide a fluid transfer system for the lubricating oil or fuel/oil mixture from the container to the engine. Lubricating oil in the container is transfered to an existing oil reservoir, directly to engine components or other machine parts.

### PRIORITY CLAIM

This application claims priority form U.S. Provisional Application Ser. No. 60/272,372 filed Feb. 27, 2001 and U.S. Provisional Application Ser. No. 60/275,587 filed Mar. 12, 2001.

### FIELD OF THE INVENTION

This invention relates generally to lubricating systems.

### BACKGROUND OF THE INVENTION

Two-cycle engines were developed as a lower cost, lightweight alternative to four-cycle engines. Two-cycle engines are commonly employed to power outboard engines, chainsaws, lawn mowers, motorcycles, weed eaters, hedge trimmers, portable blowers, power generators, hydraulic power units, or any other application where lightweight, high RPM power is required. Two-cycle gasoline engines, unlike four-cycle gasoline engines, do not have oil filled crankcases as a means of lubricating the moving parts of the engine. Rather, two-cycle engines use a blended mixture of fuel and lubricating oil as a means of powering the engine and simultaneously lubricating various parts of the engine. This blended fuel mixture requires one of two engine setups. One setup pre-blends the fuel and oil before putting it in the engine. Also, a more current trend in two-cycle engine design keeps the fuel and oil separate in their own reservoirs, and blends the fuel and oil during operation. In this second setup, the ratio of fuel to oil may depend upon power requirements. Both of these technologies have created a variety of problems common to any engine.

In the instance where an engine design does not employ pre-blended fuel, rather employing separate fuel and oil reservoirs, additional problems have developed. First, the oil reservoir must be independently checked to make sure that it contains an adequate amount of oil. As the viewing area for checking the oil level is often located in an undesirable location, an operator is required to contort themselves in awkward positions to accomplish this task. Often times, this inconvenience means that the oil level goes unchecked, which potentially leads to running the engine on no oil.

The filling of the oil reservoir requires additional tools, more specifically, funnels, spouts, rags or other such devices used to aid in filling the oil reservoir. The use of funnels to fill the oil reservoir creates a couple of problems. First, the portion of the funnel located within the reservoir at the time of filling displaces a significant volume of oil. Consequently, when the funnel is removed, the oil volume is reduced by a volume equivalent to the funnel, thus a true full reservoir is not attained. Further, the funnel's bulky shape makes it difficult to determine when the oil reservoir is nearing full, often yielding in overfilling the oil reservoir. Regardless of whether an under-filled or over-filled reservoir is attained, additional problems result from the current oil reservoir technology.

An additional problem with current engine lubrication technology is the potential of harm to the engine itself. More specifically, in instances where a reservoir is over-filled, oil residue is left upon the surface of the engine around the entrance to the reservoir. Consequently, dust and other foreign material, hazardous to internal engine components, collects around the opening to the reservoir. This combination of foreign material and oil can be introduced into the oil reservoir upon opening the reservoir or working around an open reservoir. Likewise, funnels and other such devices employed in filling the reservoir also collect dust that is potentially passed into the oil reservoir during a subsequent use. Thus, the state of current lubrication technology actually serves to increase the potential for engine harm. This problem is magnified when the environment in which these engines are employed is considered. For example, chain saws being used in forests produce vast quantities of sawdust, or motorcycles traveling along dusty roads.

Aside from the ease of use and potential damage to the engine, current engine lubrication technology is also potentially damaging to other assets around the engine. Primarily, any spilled oil or blended fuel/oil not only attaches itself to the engine, but also to anything else it happens to contact. The fuel/oil has a tendency to undesirably attach itself to other assets in the area of the engine. For example, in a marine environment oil may attach itself to fishing gear, water-skiing equipment, SCUBA gear or other such assets. The oil is often detrimental to the other assets in that it causes fouling or actual deterioration of the assets itself.

Aside from just the physical or tangible assets in the area of which the engine is employed, there are environmental concerns as well. Spillage or oil remnants are often deposited in the environment. This oil spillage in a marine application creates oil slicks on the surface of the water, damaging both surface and subsurface marine plants and animals. Further, oil spillage on dry land is absorbed into the soil potentially harming both plants and animals. Further, oil spillage is potentially damaging to water reservoirs and aquifers.

The various problems of lubrication discussed above are not limited to internal combustion engines. Rather, all machine parts or elements have similar lubrication problems or considerations. More specifically, machine parts, including milling machines, presses, drills, fabrication units, lathes, agricultural equipment, construction equipment, earth moving equipment and other mechanical devices all require sufficient lubrication in order to function properly, and all are subject to the above discussed lubrication concerns and problems.

Therefore, there exists a need to provide a clean lubricating oil or machine element lubricating system.

### SUMMARY OF THE INVENTION

The present invention comprises a disposable or reusable lubricating oil container system wherein the disposable/reusable oil container functions as the primary oil reservoir for engines or other machine parts. The container snaps, plugs into or attaches to a self-tapping repository chamber connected to a lubrication system of an engine or other machine part. The container has a neck portion defining an opening for transferring lubricating oil. The oil is transferred from the container to an engine or other machine part via a sealing unit attached to the neck. Additionally, the container can be an existing retail container for motor and engine lubricants or can be specifically designed for a given purpose.

In accordance with further aspects of the invention, a safety seal and cap are employed over the neck.

In accordance with other aspects of the invention, the container includes a graduated section or a viewing section at its surface.

In accordance with still further aspects of the invention, a strap employed secures the container to the carrier.

In accordance with yet other aspects of the invention, the sealing unit attaches to the container by a male or female coupling unit.

In accordance with other aspects of the invention, an attachment ring secures the sealing unit to the container.

In accordance with still further aspects of the invention, carrier attachments secure the carrier to an engine or machine part for damping vibration.

In accordance with yet other aspects of the invention, the carrier is a heat shield for the container.

As will be readily appreciated from the foregoing summary, the invention provides a unique disposable lubricating cartridge system.

### BRIEF DESCRIPTION OF THE DRAWINGS

The preferred and alternative embodiments of the present invention are described in detail below with reference to the following drawings.

FIG. 1 is a cross-sectional view of a disposable lubricating container and reservoir formed in accordance with the present invention;

FIG. 2 is a top view of a carrier for the container shown in FIG. 2; and

FIGS. 3 and 4 are cross-sectional side views of sealing units formed in accordance with the present invention.

### DETAILED DESCRIPTION OF THE PREFERRED EMBODIMENT

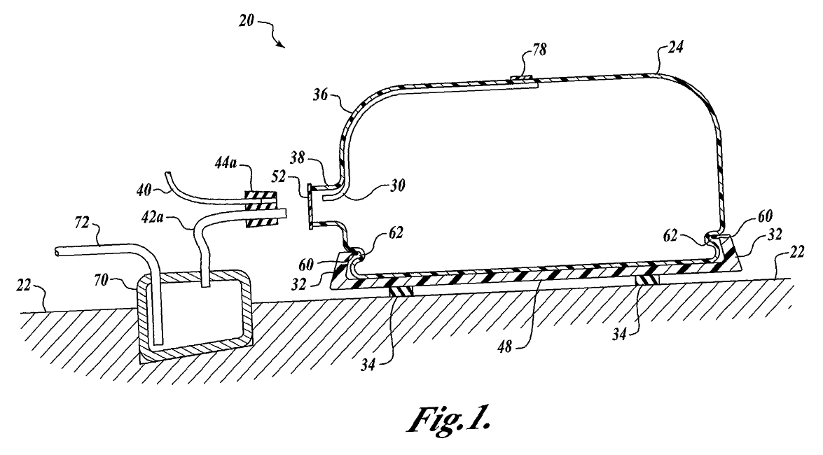

This invention preferably functions with engines employing either premixed fuel/oil or separate fuel and oil reservoir engine arrangements. However, this invention is employable with any machine part. For clarity, only the internal combustion engine with a separate reservoir arrangement is illustrated here. More specifically, FIG. 1 shows a disposable lubricating container system 20 that includes a disposable lubricating container 24 with a sealing unit 44 that is used in conjunction with an oil reservoir 70 of an internal combustion engine 22.

The overall size, shape, and design of the container system 20 is a function of the environment in which the system is employed. The container 24 can be an existing retail container for motor or engine lubricants or can be designed for a specific purpose. For example, a small container is likely to be employed with devices where space and weight are a factor, e.g., chainsaws and hand-held lawn equipment. Further, where the employment environment permits, larger, more typical container geometries may be implemented. Additionally, the container 24 can have a graduated section and/or a viewing section located on a surface of the container 24. In this manner, a visual inspection of the container 24 gives an oil level reading.

In the embodiment shown in FIG. 1, the container 24 includes a reducing area 36, a neck 38, and locking recesses 62. In the preferred embodiment, the reducing area 36 and the neck 38 are located at one end of the container 24. However, other geometries for the disposable lubricating container 24 are considered within the scope of this invention. For example, the oil container 24 may be cylindrical, rectangular, trapezoidal, square, circular or any other shape. In each physical arrangement, the location and shape of the reducing area 36 and neck 38 are controlled by the spatial limitations of the container's deployment. The neck 38 and reducing area 36 are typically employed at the lowest elevation point of the container 24 as it is oriented on the machine element. In this manner all of the lubricating oil is allowed to drain from the container 24 prior to removal of the container 24.

The neck 38 provides an opening to the inside of the container 24. The neck 38 is capped by a seal 52 prior to operation. Also, the neck 38 is designed to receive the mated sealing unit 44a. The sealing unit 44a houses a penetrating tube 42a and a vent 40 acting as a self-tapping fluid transfer system. The penetrating tube 42a is designed such that upon insertion of the sealing unit 44a into the container 24, the seal 52 is broken. The penetrating tube 42a further serves as the transfer structure for passing the lubricating oil from the container 24 to the reservoir 70, directly into a fuel/oil blending structure (not shown) if no reservoir is employed, or lubrication site of another machine element. In the preferred embodiment, the sealing unit 44a is preferably constructed from hardened rubber. However, other materials, such as polymer-based plastic and resin, are considered within the scope of this invention. When the sealing unit 44a is inserted into the neck 38, the vent 40 is in fluid communication with a cartridge vent tube 30 located on the inside of the container 24. The cartridge vent tube 30 provides air to enter the container 24 in order to equalize pressure within the container 24 as the lubricating oil is used up.

The container system 20 also includes a carrier 48 for securing the container 24 to the engine 22. However, the container system 20 can also be attached to a device employing the engine 22 or any other machine part without a carrier if desired. The carrier 48 includes locking arms 32, each with a locking arm point 60a. The locking arm points 60 are received by respective locking recesses 62 in a manner that keeps the container 24 from moving excessively. The locking arm points 60a are located on longitudinally disposed ends of the carrier 48. For example, the container can slide, snap or plug into or otherwise attach itself to the carrier. The locking arm points 60 are located on longitudinally disposed ends of the carrier 48. For example, the locking recesses 62 may run longitudinally along the sides of container 24, in a direction parallel to the central access of the container 24. The carrier 48 is designed to mate with the locking recesses 62 of the container 24 such that the carrier 48 securely holds the container 24.

Material choice for the carrier is variable. The carrier is constructed of material allowing the locking arms 32 to elastically deform while inserting the container 24 into the carrier 48 while maintaining substantially rigid characteristics. Additionally, as the carrier acts as a heat shield for the container, the material choice for the carrier preferably is thermally resistant. The carrier 48, in the preferred embodiment, is constructed of a thermal-resistant, polymer-based material, such as a thermo-set plastic. However, any other material capable of elastic deformation while maintaining substantial rigidity and thermal resistance is considered within the scope of this invention. For example, metallic, nonmetallic, or carbon-based materials, ceramics, alloys or composites thereof are employable as carrier 48 material. However, other container-attaching methods are considered within the scope of this invention.

The carrier 48 includes carrier attachments 34 for affixing the carrier 48 to another rigid body, for example, an engine 22 or a housing. The attachments 34 serve the additional purpose of damping any vibration. As such, any combination of frictional fastening devices such as bolts, screws, rivets, pins, or the like with any known damping structure such as rubber bushings, plastic bumpers, or spring dampers are examples of attachments 34.

The transfer tube 42a is connected to the reservoir 70 or other machine element and is in fluid communication with reservoir tubes 72. The reservoir 70 is illustrative of the remaining lubrication system of an engine. For clarity purposes, the specifics of any engine components have been left out of the illustration. This invention is employable with any engine arrangement or lubrication system structure.

The safety seal 52 and a cap (not shown) are located at the end of the neck 38. The cap is typically threaded on the neck and serves as a primary containment device for the lubricating oil. The seal 52 serves a secondary containment device for the oil. Typically the seal is a metallic foil that adheres to the terminal end of the neck 38. However, other seal 52 materials can be used, for example, rubber or polymer based substances.

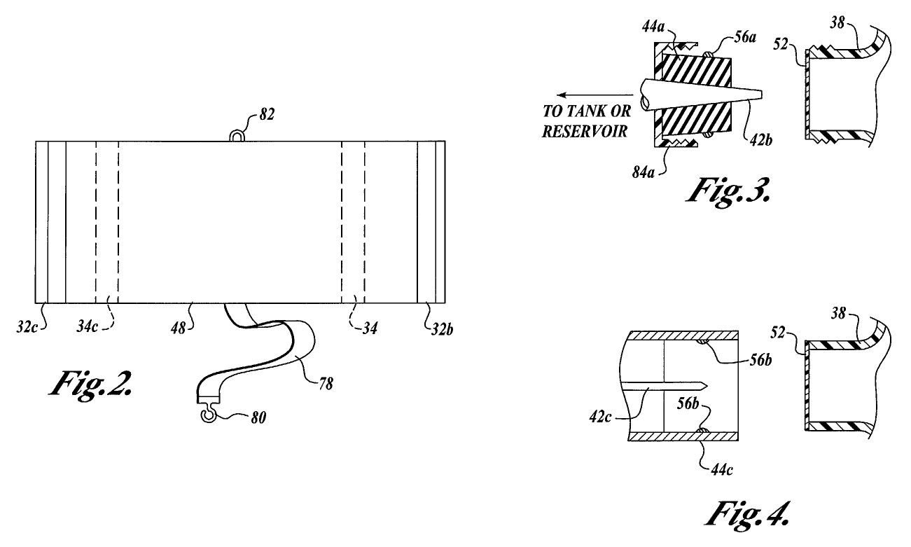

FIG. 2 is a top view of the carrier 48. The carrier 48 includes a tie strap 78 as an additional securing device for the container 24 (see FIG. 1). The tie strap 78 is preferably an elastic member designed to extend over the container 24 and further assist in securing the container 24 to the carrier 48. One end of the strap 78 is secured to a first side of the carrier 48. The tie strap 78 contains a fastener 80 attached to the end of the strap 78 not secured to the carrier 48. In the preferred embodiment, the fastener 80 is a hook. The hook of the fastener 80 attaches to a loop 82 that is secured to a side of the carrier 48 opposite the first side. Other fasteners are considered within the scope of this invention, for example, clamps, hook and loop arrangements, snaps, buckles, or clasps. Further, only one tie strap 78 is illustrated, however any number of straps, applied in any arrangement is within the scope of this invention.

FIG. 3 depicts an alternate embodiment sealing mechanism. A sealing unit 44b is designed as male insert that fits inside the neck 38 (see FIG. 1). The unit 44b includes a penetrating tube 42b. The tube 42b is hollow with a funnel-like shape capable of puncturing the safety seal 52. Further, the unit 44b includes a sealing ring 56a that is annularly located around the outer surface of the sealing unit 44b. The sealing ring 56a increases the internal biasing force of sealing unit 44b against the internal surface of neck 38 and further helps to maintain the sealing unit's positive connection with the container 24. The sealing ring 56a also serves to prevent leakage of the lubricating oil inside the container 24 to the outside environment. Additionally, an attachment ring 84 is used to further maintain the connection between the sealing unit 44 and the container 24. The attachment ring 84 is designed to threadably, or otherwise attach itself to the container 24/neck 38.

FIG. 4 shows an alternative embodiment sealing mechanism. A sealing unit 44c serves as a female counterpart for the neck 38. In this embodiment, the internal diameter of the sealing unit 44c is slightly larger then the external diameter of the neck 38. When sealing unit 44c is connected to the neck 38, neck 38 is encompassed by the sealing unit 44c and is biased by a sealing ring 56b located on the inner wall of the unit 44c. The unit 44c includes a penetrating tube 42c for puncturing the foil seal 52 and for transferring the lubricating oil within the container 24 to the reservoir 70.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A disposable/reusable lubricating oil container system for a machine part comprising:
a container having a neck defining an opening through a surface of the container, the container comprises at least one locking recess formed on the surface of the container;
a carrier for fixably attaching the container to the machine part, the carrier comprises a locking arm mated to couple with at least one locking recess of the container; and
a fluid access unit removably attachable to the neck of the container, wherein the sealing unit serves as a fluid transfer medium between the container and one or more machine components.

2. The lubricating oil container system of claim 1, wherein the container further comprises a safety seal configured to seal the container at the neck.

3. The lubricating oil container system of claim 2, wherein the safety seal material is constructed from at least one of a metallic foil, rubber or polymer-based substance.

4. The lubricating oil container system of claim 2, wherein the neck further includes a cap, threaded on an end of the neck covering the safety seal.

5. The lubricating oil container system of claim 2, wherein the fluid access unit comprises a puncture device configured to access fluid within the container by puncturing the safety seal.

6. The lubricating oil container system of claim 1, wherein the container is formed of a semi-transparent material with a measuring scale located on the surface of the container for allowing a viewer to visually determine quantity of fluid within the container.

7. The lubricating oil container system of claim 1, wherein the carrier further comprises at least one strap configured to secure the container to the carrier.

8. The lubricating oil container system of claim 1, wherein the sealing unit further comprises an attachment ring configured to secure the sealing unit to the container.

9. The lubricating oil container system of claim 1, further comprising carrier attachments configured to attach the carrier to the machine part.

10. The lubricating oil container system of claim 1, wherein the carrier is a heat shield.

11. A disposable/reusable lubricating oil container system, comprising:
a fluid holding means having a neck defining an opening through a surface of the holding means;
a means for securing the container to a machine; and
a fluid transfer means for allowing a fluid transfer between the container and a plurality of machine components.

12. The system of claim 11, wherein the means for securing further comprises at least one of a means for sliding, snapping, or plugging the container into a carrier.

13. The system of claim 11, wherein the means for securing further comprises at least one strap.

14. The system of claim 11, wherein the fluid holding means further comprises a seal means for sealing the contents of the holding means.

15. The system of claim 14, wherein the fluid transfer means comprises a puncture means for puncturing the seal means.
